(19) United States
(12) Patent Application Publication
(10) Pub. No.: US 2024/0168239 A1
(43) Pub. Date: May 23, 2024

(54) System and Methods for Optical Fiber Hermetic Sealing

(71) Applicants: Zhigang Zhou, San Jose, CA (US); Lichu Hu, San Jose, CA (US); Jie Zhou, San Jose, CA (US)

(72) Inventors: Zhigang Zhou, San Jose, CA (US); Lichu Hu, San Jose, CA (US); Jie Zhou, San Jose, CA (US)

(21) Appl. No.: 17/989,187

(22) Filed: Nov. 17, 2022

(51) Int. Cl. G02B 6/38; G02B 6/02; G02B 6/42

(52) U.S. Cl. CPC G02B 6/3825; G02B 6/02333; G02B 6/02395; G02B 6/4248

(57) ABSTRACT

An economic and reliable fiber hermetic sealing for small devices includes partially stripped optical fibers optically aligned, fixed at one end aligned with an optical source, and a cylindrical solder glass with one or multiple through holes which diameters are greater than those of the stripped fibers. A glass solder preform is contained in a ferrule structure which diameter is bigger than that of said solder glass outer diameter. The ferrule wall around the solder glass is lower than said solder glass height. The solder glass preform sits on a stepped hole with 25-75 degrees chamfered. The glass solder melts at high temperatures and flow into small hole section where the fiber is hermetically sealed and retained. An epoxy with a good adhesion to fiber coating and fiber glass is filled in the cavity blocked by molten solder glass. A glass tubing with an outer diameter greater than that of glass solder and an inner diameter greater than that of coated optical fiber is placed on top of melted solder glass and through both stripped and unstripped fiber sections. In addition, a compliant epoxy is applied on the top of glass tubing where optical fibers exit. A method of making this in accordance with the present system is also described.

### BACKGROUND OF THE SYSTEM

### 1. Field of the System

The present system relates to optical fiber hermetic feedthrough structures, in particular, an optically aligned fiber hermetical sealing assembly.

### 2. Technical Background

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances.

Optical fiber connectors are an important part of most fiber optic communication systems.

Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. Fiber hermetic sealing has been in use for active devices, such as lasers, for more than two decades. The traditional solutions use a gold metalized fiber, a gold-plated ferrule, and a form of solder. At a high temperature, for example, between 200-300 C, the solder is melted which fills the gaps between the metalized fiber and the metallic ferrule. Thus, a hermetic sealing is formed. Then an epoxy is filled in the rest of the ferrule cavity submerging the interface between stripped and unstripped parts of the fiber where the interface is a vulnerable section susceptible to external stresses. This method is reliable but metalized optical fiber is fragile and can be broken during process or handling.

Another method is to use a gold metalized pipe, usually a Kovar pipe which has a small thermal expansion coefficient to replace metallized coating on a fiber. A solder glass melts at a high temperature and seals the fiber with the Kovar pipe. Then the subassembly is sealed in a ferrule with solder melting between 200-300 C. An epoxy is filled inside the Kovar pipe to protect the interface between stripped and unstripped fiber section. Such processes are not simple since two seals are involved. On the other hand, this method is not robust, but costly.

To address the process yield issues and cost saving, a hermetic sealing was described in granted patent(s) and/or patent applications (WO/2019/184302, CN 108681001 A, CN 111766668 A). This method utilizes solder glass for direct sealing between a stripped optical fiber and a metallic ferrule. Then a glass tubing is added surrounding the interface between the stripped and unstripped fiber sections in which epoxy is filled. Because of easy processes and low cost, these systems were used in many applications. However, fiber retaining, or reliability is still an issue.

In one aspect, a fiber optic ferrule secures a fiber optic cable having a coated section and an uncoated section with an uncoated cable diameter. The ferrule includes an outer opening section having an opening diameter; a shoulder section having a funnel diameter smaller than the opening diameter; a funnel section having a funnel diameter smaller than the funnel diameter; and an inner opening section having an inner diameter larger than the uncoated cable diameter and adapted to receive the uncoated cable, wherein the opening section receives a solder glass preform that is subsequently melted to seal the uncoated section inside the ferrule.

Implementations of the ferrule can include one or more of the following. The solder glass preform can be a cylindrical solder glass with one or multiple through holes having diameters greater than the diameter of the uncoated cable diameter. The fiber optic cable can be a partially stripped optical fiber optically having a first end aligned with an optical source and a second end coupled to the opening section. The glass solder preform is contained in the ferrule whose opening diameter is bigger than that the said solder glass outer diameter. The solder glass preform sits on a stepped hole with 25-75 degrees chamfered. The glass solder is melted and flows into small hole section where the fiber is hermetically sealed and retained. Epoxy can be applied to fill in the outer opening section, the funnel section, and the inner opening section. A glass tubing with an outer diameter greater than that of glass solder and an inner diameter greater than that of coated section can be placed on top of melted solder glass and through the coated and uncoated sections.

In another aspect, a communication system includes a first optical transceiver in communication with a second optical transceiver; a fiber optic cable coupled at one end to the first optical transceiver, the fiber optic cable having a coated section and an uncoated section with an uncoated cable diameter; a fiber optic ferrule coupled to the fiber optic cable, the ferrule including: an outer opening section having an opening diameter; a shoulder section having a funnel diameter smaller than the opening diameter; a funnel section having a funnel diameter smaller than the funnel diameter; and an inner opening section having an inner diameter larger than the uncoated cable diameter and adapted to receive the uncoated cable, wherein the opening section receives a solder glass preform that is subsequently melted to seal the uncoated section inside the ferrule. In one embodiment, the glass solder is melted and flows into small hole section where the fiber is hermetically sealed and retained, comprising epoxy in the outer opening section, the funnel section, and the inner opening section.

In yet another aspect, a method to secure a fiber optic cable to a communication device with a ferrule, the fiber optic cable having a coated section and an uncoated section with an uncoated cable diameter, and the ferrule have an outer opening section having an opening diameter; a shoulder section having a funnel diameter smaller than the opening diameter; a funnel section having a funnel diameter smaller than the funnel diameter; and an inner opening section having an inner diameter larger than the uncoated cable diameter and adapted to receive the uncoated cable, wherein the opening section receives a solder glass preform that is subsequently melted to seal the uncoated section inside the ferrule. The method includes:
inserting the fiber optic cable into the outer opening;
threading the uncoated section through the inside opening section;
inserting the solder glass preform into the outer opening section; and
melting the solder glass preform to secure the fiber optic cable to the ferrule.
   Implementations may include one or more of the following. The solder glass preform comprises a cylindrical solder glass with one or multiple through holes having diameters greater than the diameter of the uncoated cable diameter. The fiber optic cable includes a partially stripped optical fiber optically having a first end aligned with an optical source and a second end coupled to the opening section. The glass solder preform is contained in the ferrule whose opening diameter is bigger than that the said solder glass outer diameter. The solder glass preform sits on a stepped hole with 25-75 degrees chamfered. The method includes melting the glass solder to flow into small hole section where the fiber is hermetically sealed and retained. The method includes applying epoxy in the outer opening section, the funnel section, and the inner opening section. The method includes applying applying a glass tubing with an outer diameter greater than that of glass solder and an inner diameter greater than that of coated section is placed on top of melted solder glass and through the coated and uncoated sections.

Advantages of the system may include one or more of the following. The system provides an improved hermetic sealing for aligned optical fibers, which improves manufacturability and reliability at reduced costs. The system addresses fiber pullout issues and multiple fiber hermetic sealing. The ferrule enables ease of manufacturing and assembly. The ferrule enables small connector size and the ability to provide enhanced connector/circuit densities. The ferrule also supports the ability to provide high signal quality connections with minimal signal degradation.

A variety of additional aspects will be set forth in the description that follows.

The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIGS. 1A-1G show exemplary operations in securing an optical fiber to a ferrule in accordance with one aspect of the invention.

FIG. 2 shows an exemplary optical fiber hermetic sealing in a butterfly or a golden box package.

FIG. 3 shows an exemplary optical fiber hermetic sealing in a co-axial package.

FIG. 4 shows an exemplary dual optical fiber hermetic sealing assembly.

FIG. 5 shows an exemplary multiple-fiber hermetic sealing assembly.

### DETAILED DESCRIPTION

In certain examples, the optical fiber includes a core, a cladding layer surrounding the core, one or more coating layers surrounding the cladding layer, and a buffer layer surrounding the one or more coating layers. In certain examples, the core can have an outer diameter in the range of 8-12 microns, the cladding can have an outer diameter in the range of 120-130 microns, the one or more coatings can have an outer diameter in the range of 240-260 microns, and the outer buffer layer can have an outer diameter in the range of 800-1,000 microns. In certain examples, the outer buffer layer can be a loose or tight buffer tube having an outer diameter of about 900 microns. In certain examples, only the core and the cladding of the optical fiber 22 are supported within the ferrule 24.

It will also be appreciated that the core and the cladding can be constructed of a material suitable for conveying an optical signal such a glass (e.g., a silica-based material). The cladding layer can have an index of refraction that is less than the index of refraction of the core. This difference between the index of refraction of the cladding layer and the index of refraction of the core allows an optical signal that is transmitted through the optical fiber to be confined to the core. In certain examples, the optical fiber is a bend insensitive fiber having multiple cladding layers separated by one or more trench layers. The one or more coating layers typically have a polymeric construction such as acrylate.

In certain examples, the optical fiber is incorporated into a fiber optic cable having a strength layer (e.g., a layer of aramid yarn) surrounded by an outer jacket. In certain embodiments, the buffer layer is eliminated and the strength layer directly surrounds the coating layer of the optical fiber. In certain examples, the fiber optic cable has an outer diameter less than 1.5 millimeters, or less than 1.4 millimeters, or less than 1.3 millimeters, or less than or equal to 1.2 millimeters. The optical fiber is then inserted into the ferrule formed in accordance with the structures below.

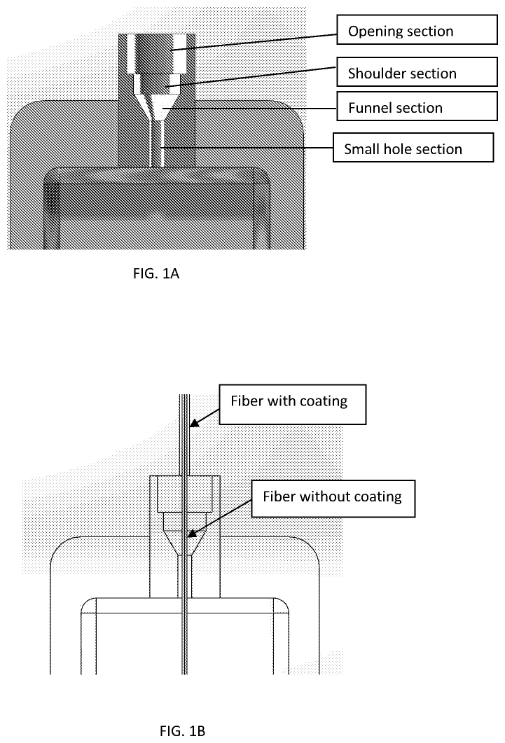

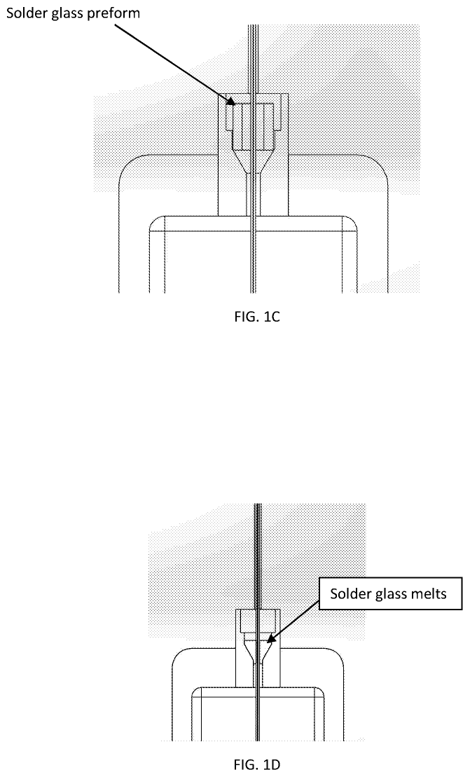

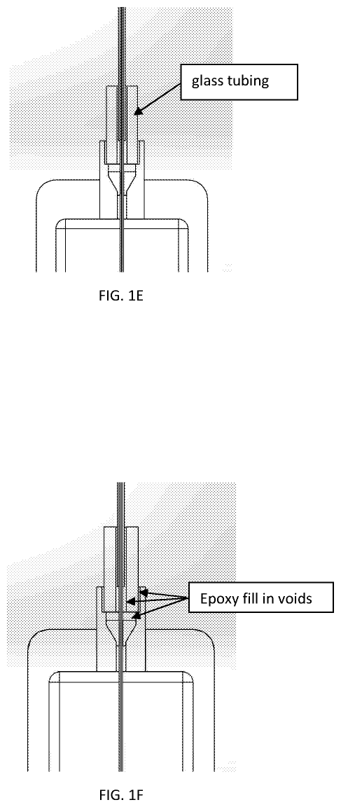

The instant ferrule structure has three sections which are, as seen in FIG. 1A: i) small hole section, ii) funnel section, iii) shoulder section, and iv) opening section. The shoulder section in FIG. 1A is to hold the solder glass in position and prevent solder glass top edges in touch with the ferrule inner walls. If a solder glass leans against the ferrule inner wall, the molten solder glass will paste and consume on the inner wall. Then less molten glass solder will flow into the small hole section which is the critical sealing part. The solder glass before molten shall be higher than the shoulder by 0.1˜0.5 times of solder glass length. The opening section of FIG. 1A provides a support for a glass tubing.

FIG. 1B shows a fiber through the package ferrule. The small hole section is to center the fiber in the ferrule structure. If the hole size is too big, the fiber may not be in the center and a solder glass which will be added later will be pushed on to one side of ferrule and in contact with the ferrule inner wall which may cause unnecessary solder glass consumption during solder glass molten state. This will result in poor sealing and/or poor fiber retaining. The small hole diameter can be in the range of 0.20-0.50 mm, dependent upon stripped fiber diameters.

FIG. 1C shows how a glass solder is placed inside the funnel section in FIG. 1A. The solder glass is a ring structure which is threaded by the fiber and sits on the funnel section. The solder glass is fairly light and its position is more controlled by the fiber position. The funnel shape is to let molten solder glass to flow into small hole section of the ferrule to have a hermetic seal. The funnel angle can be anything between 25-75 degrees, depending upon solder glass sizes and shapes.

FIG. 1D shows the solder glass solidifies after melting and flowing into the small hole section. The funnel shape helps molten solder glass flow into the small hole section where fiber is hermetically sealed.

In another aspect, the present system provides a protection of fiber stripping neck which is the interface between the stripped and unstripped fiber coating where the stress is concentrated. During mass production, fibers can easily be broken on that interface. A glass tubing is placed on the opening section of FIG. 1A and covers the cut of fiber coating. FIG. 1E shows how a glass tubing is placed in the ferrule structure. The glass tubing covers the interface between the stripped and unstripped fiber.

The inner hole of the glass tubing is then filled with an epoxy which adheres well with bare fiber glass and fiber coating which distributes stresses on that interface and therefore protects the fiber. The glass tubing inner hole diameter size shall be appropriate to let an optical fiber going through and form capillaries with said fiber so that an epoxy with an appropriate viscosity can fill in the gaps by a capillary action inside and around the glass tubing, as seen in FIG. 1F.

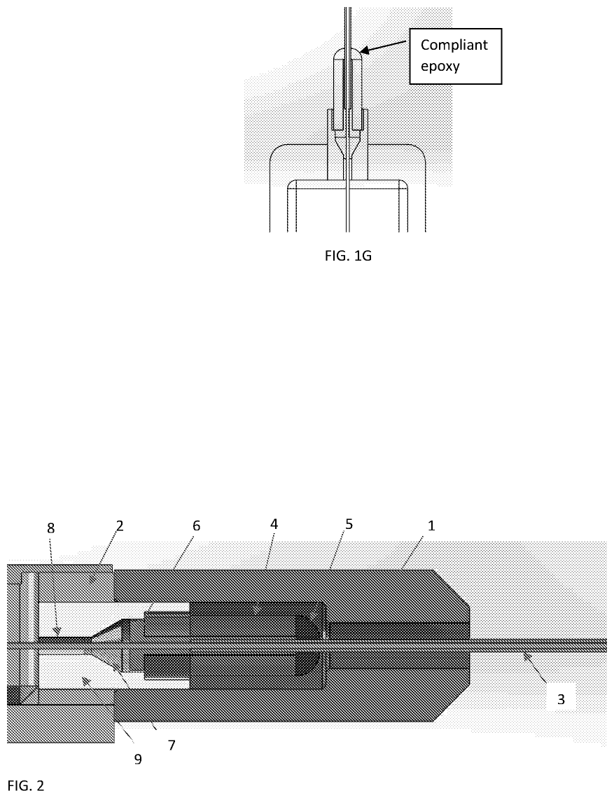

A compliant epoxy is placed on top of glass tubing where an optic fiber exits. This is to protect fibers from being pinched against sharp corners by enlarging fiber bending radius, as seen in FIG. 1G. Together with a fiber boot support, the fiber side pull strength can be largely improved as seen in FIG. 2. This also applies to multiple fibers in the same ferrule as seen in FIG. 5.

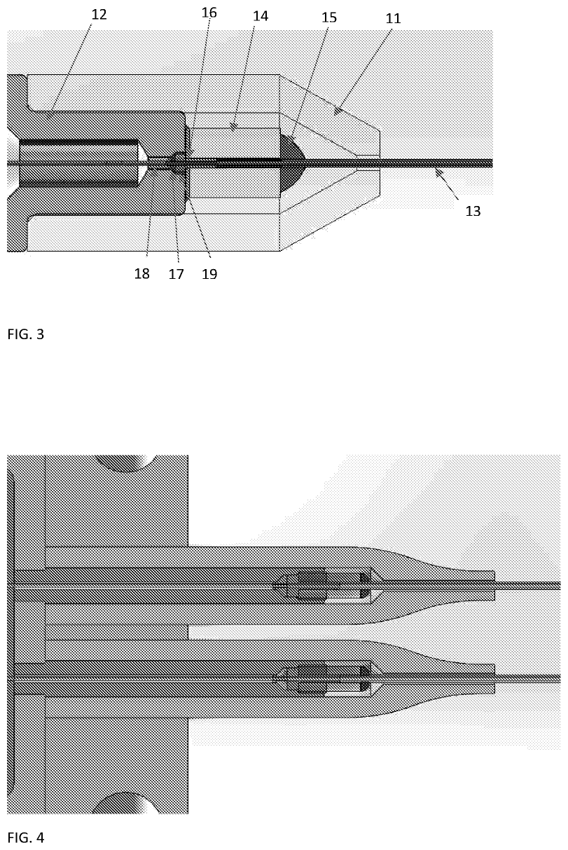

FIG. 3 is the cross section of a fiber hermetic sealing on a coaxial TO cap which shows a similar structure which includes: a small hole section, a funnel section, and a shoulder section. The open section is not there. Because there is a large flat area on the TO cap, one may attach a thicker glass tubing onto the TO cap which adhesion area is large enough. Item 16 is an extension from the TO cap for fiber hermetic sealing and boot attachment. Item 18 is the small hole section. Item 17 is the funnel section in which solder glass was melt and formed hermetic sealing. Item 19 is the shoulder section for placement of a solder glass preform. Item 16 is the channel in a glass tubing in which a fiber, part of which is stripped, and the rest part is the fiber with unstripped coating. The channel size must be greater than fiber coating outer diameter, 0.245 mm. Besides, the hole size must be small enough to make sure that capillary force is in effect. An epoxy which can adhere both stripped and unstripped fiber is filled in the channel. Item 14 is a glass tubing which outer diameter, ranging from 1-3 mm, is much larger than the channel diameter, ranging from 0.26-0.5 mm. Therefore, the glass tubing has large adhesion area on the TO cap top surface. Item 13 is an optical fiber with a coating, part of which is stripped. Item 15 is compliant epoxy which is to prevent the fiber from tight bending, or a small bending radius, less than 5 mm. Item 11 is the boot which is to support an optical fiber from side pull with less than 500 grams.

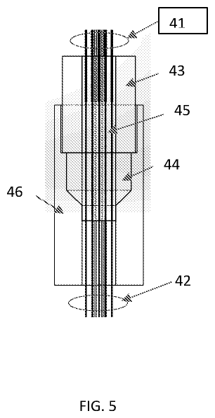

In a co-axial package, the similar approaches can be applied as seen in FIG. 3. In a TO cap, the similar fiber feedthrough structure can be formed with a small hole section, a funnel section, and a shoulder section. Because of large flat area on the TO cap, a thicker glass tubing can have large surface area for adhesion. An opening section in ferrule as in butterfly package or a golden box package is not necessary for coaxial packages. The above mentioned systems can be applied to multiple fibers with equal number of fiber feedthrough ferrules as seen in FIG. 4 and multiple fibers in a single fiber feedthrough ferrule as seen in FIG. 5 that is the cross section of multiple fiber feedthrough ferrule. Item 41 is the unstripped fibers which exit from a glass tubing, item 43. Item 42 is the stripped fibers which exit from small hole section of the ferrule, item 46. Item 44 is the glass solder in molten state in the funnel section. Item 45 is an epoxy which adheres well to both stripped fiber and unstripped fibers. The unstripped portion of the fibers are outside of the ferrule to be away from the heated ferrule during heating, e.g., induction heating.

A local heating apparatus, e.g., induction heating, is required for solder glass melt and flow. To further ensure localized heating, localized cooling, e.g., water cooling, is necessary on the areas which can't be heated too much. The associated fixture materials shall be non-inductive but with reasonable thermal conductivities.

In one embodiment, a fiber optic connector includes a ferrule assembly supported at a distal end of a connector housing. A spring may be used to bias the ferrule assembly in a distal direction relative to the connector housing. The ferrule functions to support an end portion of at least one optical fiber. In the case of a multi-fiber ferrule, the ends of multiple fibers are supported. The ferrule has a distal end faced at which a polished end of the optical fiber is located. When two fiber optic connectors are interconnected, the distal end faces of the ferrules abut one another. Often, the ferrules are biased together by at least one spring. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Although in the foregoing description, terms such as “top”, “bottom”, “front”, “back”, “rear”, “right”, “left”, “upper”, and “lower may have been used for ease of description and illustration, no restriction is intended by such use of the terms. The connectors described herein can be used in any orientation, depending upon the desired application.

The above specification, examples and data provide a description of the inventive aspects of the disclosure. Many embodiments of the disclosure can be made without departing from the spirit and scope of the inventive aspects of the disclosure.

What is claimed is:

1. A fiber optic ferrule to secure a fiber optic cable having a coated section and an uncoated section with an uncoated cable diameter, the ferrule comprising:
an outer opening section having an opening diameter;
a shoulder section having a funnel diameter smaller than the opening diameter;
a funnel section having a funnel diameter smaller than the funnel diameter; and
an inner opening section having an inner diameter larger than the uncoated cable diameter and adapted to receive the uncoated cable,
wherein the opening section receives a solder glass preform that is subsequently melted to seal the uncoated section inside the ferrule.

2. The ferrule of claim 1, wherein the solder glass preform comprises a cylindrical solder glass with one or multiple through holes having diameters greater than the diameter of the uncoated cable diameter.

3. The ferrule of claim 1, wherein the fiber optic cable comprises a partially stripped optical fiber optically having a first end aligned with an optical source and a second end coupled to the opening section.

4. The ferrule of claim 1, wherein the glass solder preform is contained in the ferrule whose opening diameter is bigger than that the said solder glass outer diameter.

5. The ferrule of claim 1, wherein the solder glass preform sits on a stepped hole with 25-75 degrees chamfered.

6. The ferrule of claim 1, wherein the glass solder is melted and flows into small hole section where the fiber is hermetically sealed and retained.

7. The ferrule of claim 1, comprising epoxy in the outer opening section, the funnel section, and the inner opening section.

8. The ferrule of claim 1, comprising a glass tubing with an outer diameter greater than that of glass solder and an inner diameter greater than that of coated section is placed on top of melted solder glass and through the coated and uncoated sections.

9. A communication system, comprising:
a first optical transceiver in communication with a second optical transceiver;
a fiber optic cable coupled at one end to the first optical transceiver, the fiber optic cable having a coated section and an uncoated section with an uncoated cable diameter;
a fiber optic ferrule coupled to the fiber optic cable, the ferrule including:
an outer opening section having an opening diameter;
a shoulder section having a funnel diameter smaller than the opening diameter;
a funnel section having a funnel diameter smaller than the funnel diameter; and
an inner opening section having an inner diameter larger than the uncoated cable diameter and adapted to receive the uncoated cable,
wherein the opening section receives a solder glass preform that is subsequently melted to seal the uncoated section inside the ferrule.

10. The system of claim 9, wherein the glass solder is melted and flows into small hole section where the fiber is hermetically sealed and retained, comprising epoxy in the outer opening section, the funnel section, and the inner opening section.

11. A method to secure a fiber optic cable to a communication device with a ferrule, the fiber optic cable having a coated section and an uncoated section with an uncoated cable diameter, and the ferrule have an outer opening section having an opening diameter; a shoulder section having a funnel diameter smaller than the opening diameter; a funnel section having a funnel diameter smaller than the funnel diameter; and an inner opening section having an inner diameter larger than the uncoated cable diameter and adapted to receive the uncoated cable,
wherein the opening section receives a solder glass preform that is subsequently melted to seal the uncoated section inside the ferrule, the method comprising:
inserting the fiber optic cable into the outer opening;
threading the uncoated section through the inside opening section;
inserting the solder glass preform into the outer opening section; and
melting the solder glass preform to secure the fiber optic cable to the ferrule.

12. The method of claim 11, wherein the solder glass preform comprises a cylindrical solder glass with one or multiple through holes having diameters greater than the diameter of the uncoated cable diameter.

13. The method of claim 11, wherein the fiber optic cable comprises a partially stripped optical fiber optically having a first end aligned with an optical source and a second end coupled to the opening section.

14. The method of claim 11, wherein the glass solder preform is contained in the ferrule whose opening diameter is bigger than that the said solder glass outer diameter.

15. The method of claim 11, wherein the solder glass preform sits on a stepped hole with 25-75 degrees chamfered.

16. The method of claim 11, comprising melting the glass solder to flow into small hole section where the fiber is hermetically sealed and retained.

17. The method of claim 11, comprising applying epoxy in the outer opening section, the funnel section, and the inner opening section.

18. The method of claim 11, comprising applying a glass tubing with an outer diameter greater than that of glass solder and an inner diameter greater than that of coated section is placed on top of melted solder glass and through the coated and uncoated sections.
